(19) United States
(12) Patent Application Publication
(10) Pub. No.: US 2008/0105138 A1
(43) Pub. Date: May 8, 2008

(54) Cooking apparatus

(75) Inventor: Fabio Segato, Vignola (MO) (IT)

Correspondence Address: NIXON & VANDERHYE, PC, 901 NORTH GLEBE ROAD, 11TH FLOOR, ARLINGTON, VA, 22203, US

(73) Assignee: Angelo Po Grandi Cucine - Societa' Per Azioni, Carpi (MO) (IT)

(21) Appl. No.: 11/907,264

(22) Filed: Oct. 10, 2007

(30) Foreign Application Priority Data
Nov. 3, 2006 (IT) MO2006A000354

(51) Int. Cl. A47J 37/00

(52) U.S. Cl. 99/447

(57) ABSTRACT

An apparatus for cooking foods comprises a cooking chamber, a fan device for circulating air and/or steam inside said cooking chamber, a first conduit arrangement and a second conduit arrangement respectively for the entry into said cooking chamber of air removed from an external environment and for the exit from said cooking chamber of air and/or steam, in a first operating condition of said apparatus, said first conduit arrangement being so arranged as to enable air and/or steam to exit from said cooking chamber when a preset threshold pressure is reached inside the latter, in a second operating condition of said apparatus in which said second conduit arrangement is shut.

### CROSS REFERENCE TO RELATED APPLICATION

This application is a new U.S. utility application claiming priority benefit of IT M02006A000354, filed Nov. 3, 2006, the entire contents of which are hereby incorporated by reference.

The invention refers to a cooking apparatus for foods, in particular a combined or mixed convection and steam oven for professional use.

### BACKGROUND OF THE INVENTION

Cooking apparatuses or combined ovens are known that enable foods to be cooked using hot air and water vapour, separately or in combination, depending on the type and features of the foods.

In so-called “direct generation” cooking apparatuses or ovens, the increase in the quantity of steam inside a cooking chamber is obtained by directly introducing into the latter preset quantities of water that is transformed into steam owing to the heat transferred from an electric or gas heating device located in the chamber.

A fan device is provided for circulating in a uniform manner the air or mixture of air and steam inside the cooking chamber. The fan device can also be used for nebulising water introduced into the cooking chamber, promoting the transformation thereof into steam.

In order to ensure desired cooking of food, it is necessary to check during the entire cooking process not only the temperature but also the level of humidity in the oven. For example, if it is desired to increase the quantity of steam, water is introduced into the cooking chamber in a suitably controlled manner. Conversely, if it is desired to have a low level of humidity, it is necessary to let the steam escape that is inside the cooking chamber and simultaneously allow air to enter from the external environment.

In order to achieve this adjustment, known ovens generally have a first suction conduit, which enables more or less dry air removed from the environment to enter, and a second ventilation or discharge conduit for the exit of the excess steam.

Along the ventilation conduit one or more nozzles are provided, arranged for nebulising a quantity of water that is sufficient to cool and filter the exiting mixture of steam and air. The condensate that is created is collected and discharged from suitable drainage discharges made along the ventilation conduit.

On the suction conduit a known closing device is normally placed, for example a butterfly valve, which is drivable manually or automatically through a control device. The ventilation conduit is normally always left open so as to also perform a safety function against possible accidental overpressure or vacuums that may be generated in the cooking chamber.

The end section of the suction conduit is normally positioned in zones of the cooking chamber where there is a vacuum, thus obtaining a greater flow of water coming from the exterior and thus promoting more effective and rapid evacuation of the steam.

On the other hand when it is desired to increase the quantity of steam in the cooking chamber, the suction conduit is shut by the closing device, thereby interrupting the flow of air from the exterior. Nevertheless, part of the steam in the cooking chamber is inevitably lost through the ventilation conduit, which always remains open. Ovens of this type thus have the drawback of not being able to reach high percentages of steam inside the cooking chamber and of requiring a greater consumption of water to compensate for the steam that exits the ventilation conduit.

In order to overcome this limit, other known ovens use systems that are suitable for producing slight overpressure in the cooking chamber so as to retain a greater quantity of steam. Said systems require closing devices on all the ventilation and/or suction conduits communicating with the exterior and, furthermore, have to be provided with protection devices such as counterweight valves, water head systems, against possible accidental overpressure and/or vacuums that could compromise the structural integrity of the oven and safety for the operator. Such systems are therefore more complex and more costly.

An object of the invention is to improve the apparatuses for cooking foods, in particular combined convection and steam ovens.

Another object is to make an apparatus that enables steam to be evacuated effectively and rapidly during convection cooking and/or a large quantity of humidity to be obtained in steam cooking.

A further object is to make a cooking apparatus having great energy efficiency in steam cooking, with simultaneous reduction of water consumption.

Still another object is to make a robust and reliable apparatus that is unlikely to be subject to malfunctions and breakages.

### BRIEF DESCRIPTION OF THE DRAWINGS

The invention can be better understood and implemented with reference to the enclosed drawings, which illustrate an embodiment thereof by way of non-limiting example, in which:

FIG. 1 is a schematic view of a first embodiment of the cooking apparatus according to the invention in a first operating condition;

FIG. 2 is a schematic view of the apparatus in FIG. 1 in a second operating condition;

FIG. 3 is a schematic view of a second embodiment of the cooking apparatus according to the invention in the first operating condition;

FIG. 4 is a schematic view of the apparatus in FIG. 3, in the second operating condition.

### DESCRIPTION OF THE INVENTION

According to the invention there is provided an apparatus for cooking foods comprising a cooking chamber, a fan device for circulating air and/or steam inside said cooking chamber, a first conduit arrangement and a second conduit arrangement respectively for the entry into said cooking chamber of air removed from an external environment and for the exit from said cooking chamber of air and/or steam in a first operating condition of said apparatus, said first conduit arrangement being arranged so as to enable the air and/or steam to exit said cooking chamber when a preset threshold pressure is reached inside the latter, in a second operating condition of said apparatus in which said second conduit arrangement is shut.

Owing to the invention it is possible to make a cooking apparatus, in particular a combined oven for convection and steam cooking of foods, that enables steam to be evacuated effectively and rapidly in the first operating condition and, vice versa, to obtain a great quantity of humidity in the cooking chamber in said second operating condition. This is possible due to the fact that the first conduit arrangement is connected to the cooking chamber at a suction/vacuum zone of the fan device. This vacuum promotes the entry of external air and thus enables steam to be evacuated effectively and rapidly when the second conduit arrangement is open. On the other hand, when the second conduit arrangement is shut, the first conduit arrangement enables excess air and/or steam to exit said cooking chamber only when a preset threshold pressure is exceeded, which is necessary to overcome the vacuum generated by the rotating fan device. It is thus possible to ensure inside the cooking chamber a high percentage of steam and at the same time avoid dangerous pressure increases that could damage the apparatus. The first conduit arrangement is, in fact, always open and there are no safety devices that could jam or break.

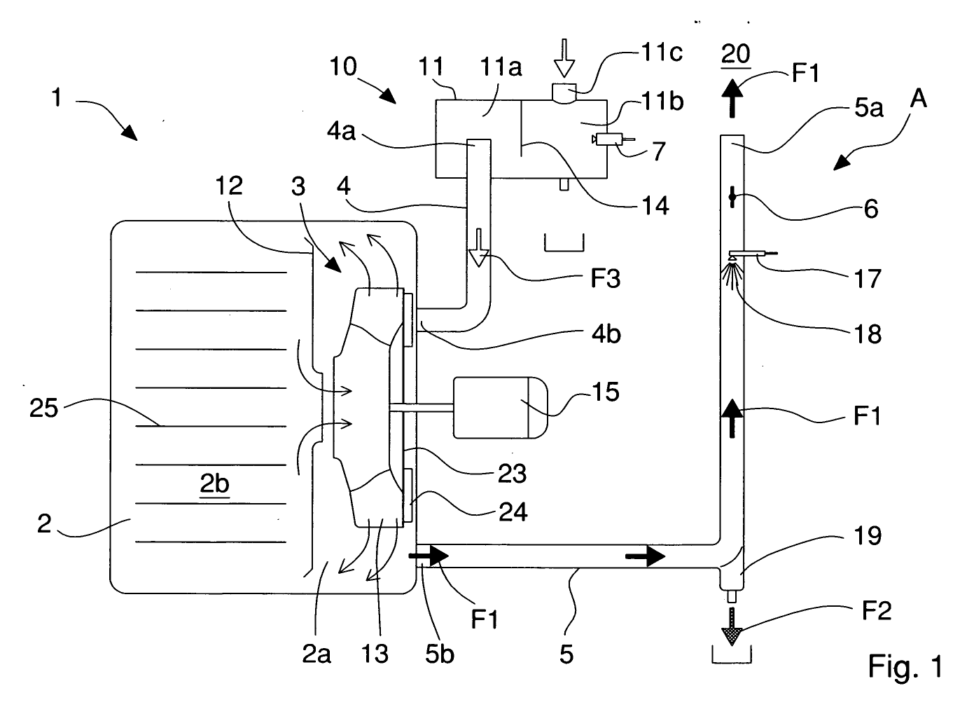

With reference to FIG. 1, there is illustrated an apparatus 1 for cooking foods, in particular a combined convection and steam oven, comprising a cooking chamber 2 arranged for containing foods to be cooked on a plurality of shelves 25, a fan device 3 suitable for circulating air and/or steam inside said cooking chamber 2, a first conduit arrangement 4 and a second conduit arrangement 5 that connect the inside of said cooking chamber 2 to an external environment 20 in which the apparatus is located.

In a first operating condition A of the apparatus 1, the first conduit arrangement 4 enables air from the external environment 20 to enter said cooking chamber 2 whilst the second conduit arrangement 5 enables the cooking chamber 2 to be ventilated, i.e. enables excess air and/or steam to exit therefrom.

The first conduit arrangement 4 comprises at least a first conduit provided with a first end 4a, communicating with the external environment 20, and with a second end 4b that leads inside the cooking chamber 2, at a rear disc 23 to which main blades 13 of the fan device 3 are fixed.

The latter is housed in a ventilation gap 2a of the cooking chamber 2 that is separated from a cooking zone 2b by a separating wall 12.

The dynamic effect due to the rotation of the fan device 3 creates an air vacuum in a zone adjacent to the second end 4b of the conduit 4, so as to suck air from outside inside the cooking chamber 2 through said first conduit 4. More precisely, locally in said zone a decrease in air pressure is determined, the value of which becomes less than that of the pressure in the external environment 20, enabling air to enter.

This dynamic suction/vacuum effect can be further increased by using a series of auxiliary blades 24 fixed to the rear disc 23 of the fan device 3, on a side opposite the main blades 13.

The air sucked from the external environment 20 and the air coming from the centre of the cooking chamber 2 are conveyed radially by the blades 13 of the ventilation gap 2a again to the cooking zone 2b.

The second conduit arrangement 5 comprises at least a second conduit provided with respective first end 5a, communicating with the external environment 20, and a respective second end 5b that leads inside the cooking chamber 2, at the ventilation gap 2a, in a zone outside the zone occupied by the fan device 3.

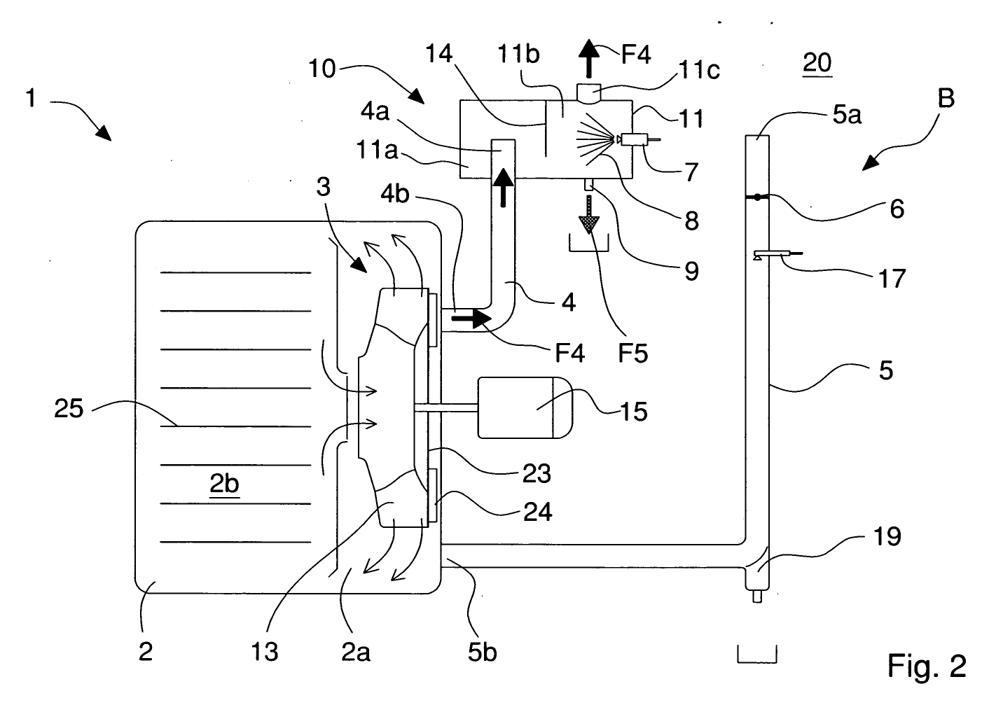

Inside the second conduit 5 there is inserted near the respective first end 5a, a valve 6 suitable for closing or opening said conduit to prevent or enable a mixture of air and steam to exit. The valve 6 comprises, for example, a butterfly valve of known type, driven, for example, by an actuator of known type and not illustrated in the Figures. The apparatus 1 comprises a condensing device 10 suitable for condensing and/or filtering steam exiting the cooking chamber 2 through the first conduit 4 in a second operating condition B of the cooking apparatus 1, in which the valve 6 is shut and prevents the mixture of air and steam exiting through the second conduit 5 (FIG. 2).

The condensing device 10 comprises a boxed casing 11 divided internally into a first cavity 11a and a second cavity 11b, partially separated by a baffle 14. The respective first end 4a of the first conduit 4 leads inside the first cavity 11a, whilst the second cavity 11b is directly connected to the external environment 20 by means of a connecting opening 11c. An injecting element 7 is fixed to the boxed casing 11 and arranged for spraying and nebulising a jet of water 8 inside the second cavity 11b in order to condense and/or filter the mixture of air and steam exiting the cooking chamber 2 through the first conduit 4.

A draining element 9 is provided on the bottom of the second cavity 11b to collect and discharge the condensate that forms during operation. The baffle 14 prevents splashes and/or drops of water introduced by the injecting element 7 from finishing inside the first conduit 4 and, therefore, the cooking chamber 2. Further, the end 4a of the conduit 4 is located at a higher level than the bottom of the casing 11, so as to prevent possible standing water on the bottom from flowing inside the cooking chamber 2.

Similarly, inside the second conduit 5 upstream of the valve 6 there is provided a further injecting element 17 suitable for spraying and nebulising a further jet of water 18 that is necessary for condensing and/or filtering the steam exiting the cooking chamber 2 in the first operating condition A of the apparatus 1. A further draining element 19 is provided for collecting and discharging the condensate.

The operation of the cooking apparatus 1 provides in the first operating condition A for the valve 6 being arranged in an open position to enable the excess air and steam to exit through the second conduit 5 and in this manner reduce the percentage of humidity inside the cooking chamber 2 during cooking of food. The exiting flow of air and steam is indicated by the arrows F1 in FIG. 1.

The excess steam is condensed inside the second conduit 5 by the nebulised jet of water 18 sprayed by the further injecting element 17 and discharged outside (arrow F2).

Simultaneously to the exit of the steam, through the first conduit 4 a flow of air enters the cooking chamber that is sucked owing to the fan device 3 from the external environment 20 (arrows F3 of FIG. 1). The sucked air passes through the cavities 11a, 11b of the boxed casing 11, with the injecting element 7 deactivated.

The flow of sucked air is a function of the vacuum created by the fan device 3 and of the pressure difference existing between the inside of the cooking chamber 2 and the external environment 20. This flow can possibly be varied and adjusted by acting on the rotation speed of the fan device 3 i.e. motor arrangement 15 assigned to the driving thereof.

In the second operating condition B of the cooking apparatus 1, the valve 6 is arranged in a shut position so as to prevent the air and steam exiting from the cooking chamber 2. The excess steam inside the latter can thus exit only through the first conduit 4, which is in flow connection with the external environment 20. The flow of steam is indicated by the arrows F4 in FIG. 2.

Nevertheless, the excess steam can exit only when inside the cooking chamber 2 a threshold pressure is exceeded such as to overcome the vacuum generated by the fan device 3. More precisely, to this threshold pressure in the cooking chamber 2 there corresponds pressure at the second end 4b above the pressure of the external environment 20. This enables a high percentage of steam to be maintained inside the cooking chamber 2 and dangerous increases in pressure to be avoided at the same time.

In the second operating condition B the injecting element 7 is activated and sprays a nebulised jet of water to enable the exiting steam to be condensed (arrow F5 of FIG. 2).

The valve 6 can be opened manually or automatically by means of a control unit of the apparatus 1, which control unit is not illustrated, that controls the temperature and/or pressure and/or humidity level inside the cooking chamber 2. For this purpose, the apparatus 1 can be provided with sensors, such as thermometers, gauges, humidity gauges, located inside the cooking chamber 2 and connected to the control unit.

Alternatively or in addition to such sensors, temperature sensors can be provided that are arranged inside the conduit 4 or in one of the two cavities of the condensing device 10 so as to identify the moment at which the pressure in the cooking chamber exceeds the set threshold and the excess steam starts to exit through the conduit 4.

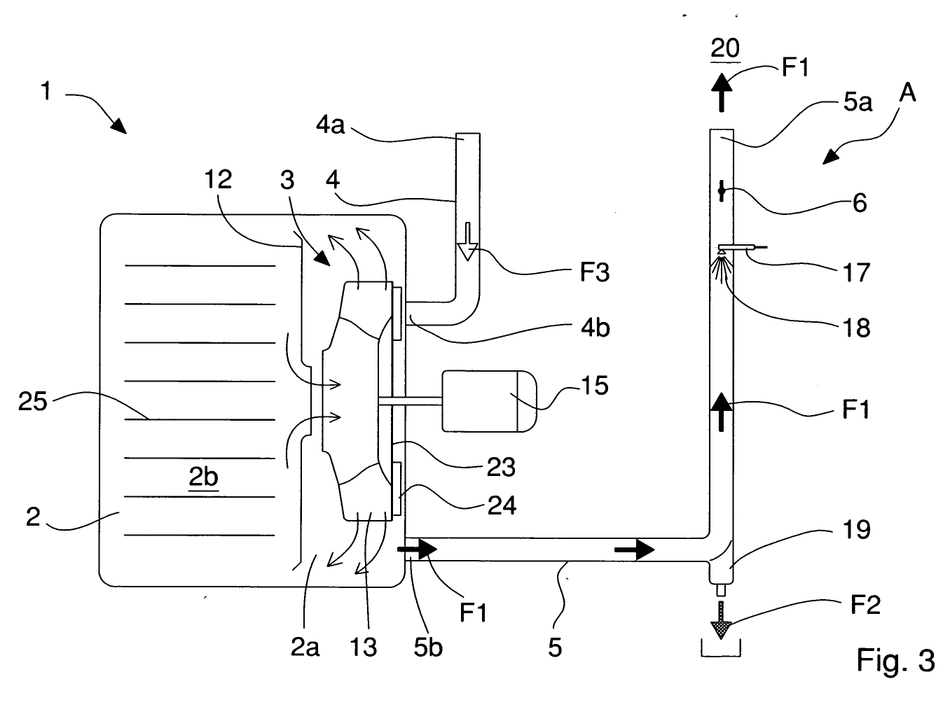

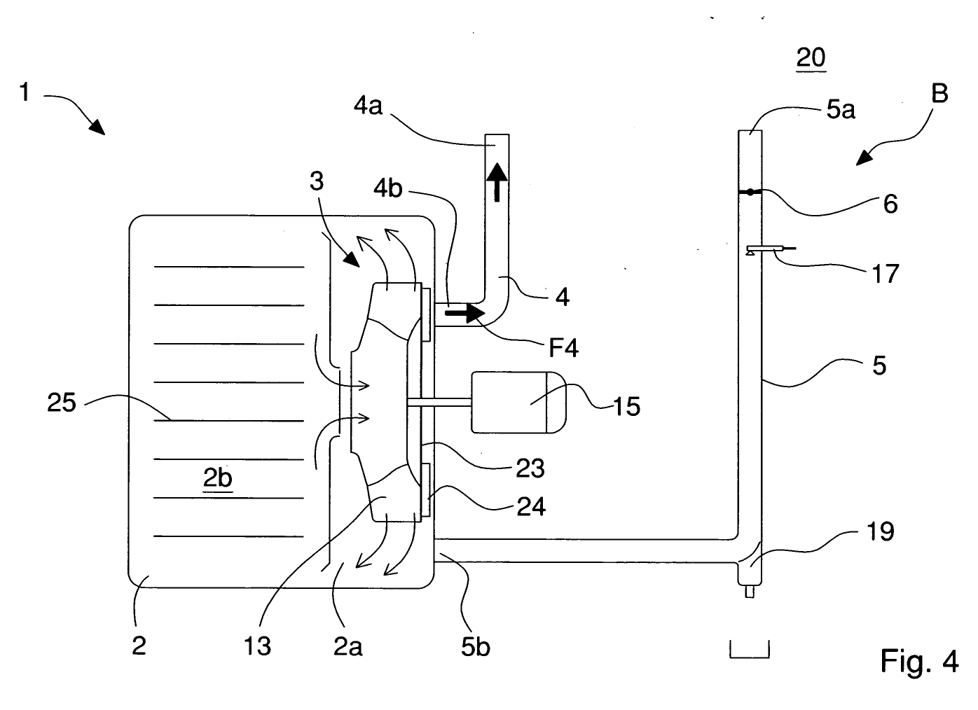

In FIGS. 3 and 4 there is illustrated a second embodiment of a cooking apparatus 1a according to the invention. In this second embodiment the cooking apparatus 1a is devoid of the condensing device 10 and of the corresponding injecting element 7, so that the end 4a of the conduit 4 leads directly into the environment outside the apparatus 1a. In the operating condition A, shown in FIG. 3, the operation of the apparatus 1a is completely similar to the operation of the apparatus 1 illustrated in FIGS. 1 and 2, with the sole difference that the flow of incoming air shown by the arrow F3 enters directly from the external environment inside the conduit 4. In the operating condition B, shown in FIG. 4, the flow of steam F4 exits directly into the external environment through the conduit 4 without undergoing any condensation or cooling. The further injecting element 17 can be located near the end 5b of the conduit 5. Furthermore, the distance between the ends 5b and 4b respectively of the conduits 5 and 4 can be minimised. In these cases, the further injecting element 17 is maintained active in the second operating condition B. In fact, it has been shown experimentally that the injection of water through the further injecting element 17, in the second operating condition B, causes a slight decrease in the quantity of exiting steam F4 without adversely affecting the quantity of steam in the cooking chamber.

Thus, in the second embodiment shown in FIGS. 3 and 4, in order to contain the quantity of steam emitted into the environment by the apparatus 1a, the further injecting element 17 can be maintained active, in a continuous or timed manner, also in the operating condition B. This second embodiment, whilst being less efficient in eliminating the steam exiting the apparatus 1a, is certainly cheaper and constructionally simpler than the previous one. Further, the absence of the condensing device 10 and of the injecting element 7 does not affect the operation of the apparatus 1a, maintaining the previously illustrated advantages of the invention.

1. Apparatus for cooking foods comprising a cooking chamber, a fan device for circulating air and/or steam inside said cooking chamber, a first conduit arrangement and a second conduit arrangement respectively for the entry into said cooking chamber of air removed from an external environment and for the exit from said cooking chamber of air and/or steam, in a first operating condition of said apparatus, said first conduit arrangement being so arranged as to enable air and/or steam to exit from said cooking chamber when a preset threshold pressure is reached inside the latter, in a second operating condition of said apparatus in which said second conduit arrangement is shut.

2. Apparatus according to claim 1, wherein said first conduit arrangement comprises at least a first conduit provided with a first end leading into said external environment and a second end leading inside said cooking chamber at said fan device.

3. Apparatus according to claim 2, wherein said fan device is configured for generating by rotating a vacuum, at said second end, so as to draw an airflow inside said cooking chamber from the external environment in said first operating condition.

4. Apparatus according to claim 3, wherein said threshold pressure enables excess air and/or steam inside said cooking chamber to overcome said vacuum and exit through said first conduit arrangement into the external environment, in said second operating condition.

5. Apparatus according to claim 1, wherein said fan device comprises a plurality of main blades fixed to a rear disc.

6. Apparatus according to claim 5, wherein said fan device comprises a plurality of auxiliary blades fixed to a side of said rear disc opposite said main blades.

7. Apparatus according to claim 5, wherein said second end of said first conduit arrangement almost faces said rear disc.

8. Apparatus according to claim 6, wherein said second end almost faces said auxiliary blades.

9. Apparatus according to claim 1, comprising a condensing device associated with said first conduit arrangement and suitable for condensing and/or filtering air and/or steam exiting from said cooking chamber in said second operating condition.

10. Apparatus according to claim 9, wherein said condensing device comprises a casing arrangement provided with a cavity arrangement suitable for containing said first end of said first conduit arrangement and provided with an opening connecting said casing arrangement to said external environment.

11. Apparatus according to claim 10, wherein said condensing device comprises an injecting element suitable for spraying and/or nebulising a cooling liquid, in particular water, inside said casing arrangement to condense said air and/or steam.

12. Apparatus according to claim 10, wherein said condensing device comprises a draining element suitable for collecting and conveying outside said casing arrangement condensate formed by the condensation of said air and/or steam.

13. Apparatus according to claim 12, wherein said first conduit arrangement comprises at least a first conduit provided with a first end leading into said external environment and a second end leading inside said cooking chamber at said fan device and wherein said first end of said first conduit arrangement is at a higher level than said draining element.

14. Apparatus according to claim 10, wherein said cavity arrangement comprises a first cavity and a second cavity partially separated by a baffle element and in flow connection respectively to said first end and to said external environment.

15. Apparatus according to claim 14, wherein said condensing device comprises an injecting element suitable for spraying and/or nebulising a cooling liquid, in particular water, inside said casing arrangement to condense said air and/or steam and wherein said injecting element is arranged for spraying said cooling liquid inside said second cavity.

16. Apparatus according to claim 1, wherein said second conduit arrangement comprises at least a second conduit provided with a respective first end leading into said external environment and with a respective second end leading inside said cooking chamber.

17. Apparatus according to claim 1, and further comprising a valve device arranged selectively for opening or shutting said second conduit arrangement.

18. Apparatus according to claim 9, and further comprising a further injecting element suitable for spraying a respective cooling liquid, in particular water, inside said second conduit arrangement for condensing and/or filtering air and/or steam exiting from said cooking chamber in said first operating condition.

19. Apparatus according to claim 1, and further comprising an injecting member suitable for spraying a respective cooling liquid, in particular water, inside said second conduit arrangement.

20. Apparatus according to claim 19, wherein said injecting member is arranged near said second end of said second conduit arrangement.

21. Apparatus according to claim 19, and further comprising a draining member suitable for collecting and conveying outside said second conduit arrangement condensate formed by the condensation of said air and/or steam.

22. Apparatus according to claim 17, comprising a control unit for controlling an actuating device arranged for driving said valve device.

23. Apparatus according to claim 1, comprising a sensor arrangement suitable for detecting inside said cooking chamber at least one between pressure, temperature, degree of humidity.

24. Apparatus according to claim 23, wherein said sensor arrangement is arranged inside said first conduit arrangement and/or inside a condensing device associated with said first conduit arrangement and suitable for condensing and/or filtering air and/or steam exiting from said cooking chamber in said second operating condition.

25. Apparatus according to claim 23, and further comprising a valve device arranged selectively for opening or shutting said second conduit arrangement and a control unit for controlling an actuating device arranged for driving said valve device, wherein said sensor arrangement is connected to said control unit.
